(19) United States
(12) Patent Application Publication
(10) Pub. No.: US 2023/0244586 A1
(43) Pub. Date: Aug. 3, 2023

(54) ELECTRONIC DEVICE

(71) Applicant: ASUSTEK COMPUTER INC., TAIPEI (TW)

(72) Inventors: Fu-Yu CAI, TAIPEI (TW); Chun-Fu CHEN, TAIPEI (TW); Che-Hsiung CHAO, TAIPEI (TW); Ming-Chih HUANG, TAIPEI (TW); Tong-Shen HSIUNG, TAIPEI (TW); Shang-Chih LIANG, TAIPEI (TW)

(21) Appl. No.: 17/948,920

(22) Filed: Sep. 20, 2022

(30) Foreign Application Priority Data
Jan. 28, 2022 (CN) 202210104592.6
Aug. 25, 2022 (CN) 202211024516.0

(51) Int. Cl. G06F 11/32; H01H 13/83; G06F 3/02; H05B 47/105; G06F 1/16

(52) U.S. Cl. CPC G06F 11/326; G06F 1/1616; G06F 3/021; H01H 13/83; H05B 47/105

(57) ABSTRACT

The disclosure provides an electronic device. The electronic device includes a computer system, a light emitting module, and a control unit. The computer system is adapted to execute a boot procedure, the boot procedure lasting for a first time period. A light emitting module includes a plurality of indicator lights, each indicator light providing an indication function. The control unit is electrically connected to the light emitting module. The control unit controls the indicator lights to generate a first light emitting effect within a second time period when the computer system enters the boot procedure. The second time period is shorter than the first time period.

### CROSS-REFERENCE TO RELATED APPLICATION

This application claims the priority benefit of Chinese application serial No. 202210104592.6, filed on Jan. 28, 2022, and Chinese application serial No. 202211024516.0, filed on Aug. 25, 2022. The entirety of the above-mentioned patent applications are hereby incorporated by reference herein and made a part of the specification.

### BACKGROUND OF THE INVENTION

### Field of the Invention

The disclosure relates to an electronic device, and in particular, to an electronic device with an indicator light.

### Description of the Related Art

An indicator light is disposed on a casing of an electronic device (such as a notebook computer) to allow a user to quickly know the status of the electronic device. However, an indicator light of a conventional electronic device providing an unvaried light emitting pattern. The indicator light only provides the function of indicating a status, but cannot clearly inform a user that the electronic device is turned on.

### BRIEF SUMMARY OF THE INVENTION

The disclosure provides an electronic device. The electronic device includes a computer system, a light emitting module, and a control unit. The computer system is adapted to execute a boot procedure, the boot procedure lasting for a first time period. A light emitting module includes a plurality of indicator lights, each indicator light providing an indication function. The control unit is electrically connected to the light emitting module. The control unit controls the indicator lights to generate a first light emitting effect within a second time period when the computer system enters the boot procedure. The second time period is shorter than the first time period.

According to the disclosure, after the computer system enters the boot procedure, the indicator lights of the electronic device are directly configured to present a dynamic first light emitting effect, to inform a user that the computer system is booting. Therefore, the electronic device in the disclosure does not need to additionally set light signals for a light emitting effect of the boot procedure. In addition, this light emitting effect can inform the user that the computer system is booting and show a special sense of ritual, which highlights the uniqueness of the electronic device.

### BRIEF DESCRIPTION OF THE DRAWINGS

FIG. 1 is a schematic block diagram of an electronic device according to an embodiment of the disclosure;

FIG. 2 is a schematic three-dimensional diagram of a light emitting module according to an embodiment of the disclosure;

FIG. 3A to FIG. 3E show a first light emitting effect generated by a light emitting module according to an embodiment of the disclosure;

FIG. 4 is another schematic block diagram of an electronic device according to an embodiment of the disclosure; and

FIG. 5 is a schematic three-dimensional diagram of an electronic device according to an embodiment of the disclosure.

### DETAILED DESCRIPTION OF THE EMBODIMENTS

More detailed descriptions of the specific embodiments of the disclosure are provided below with reference to the accompanying drawings. The features and advantages of the disclosure are described more clearly according to the following description and claims. It is to be noted that all of the drawings use very simplified forms and imprecise proportions, only being used for assisting in conveniently and clearly explaining the objective of the embodiments of the disclosure.

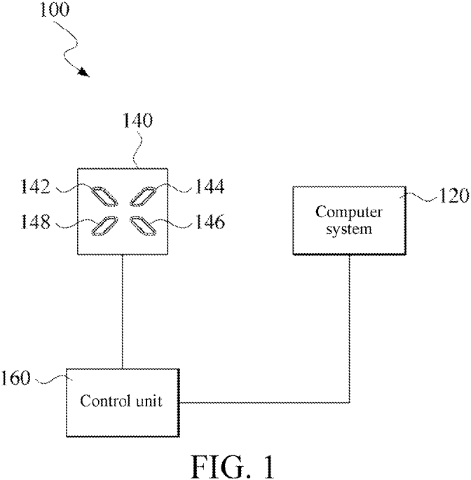

FIG. 1 is a schematic block diagram of an electronic device according to an embodiment of the disclosure. The electronic device is an electronic device with a computer system, for example, a notebook computer, a desktop computer, or a tablet computer.

As shown in the figure, this electronic device 100 includes a computer system 120, a light emitting module 140, and a control unit 160. The computer system 120 is adapted to execute a boot procedure, the boot procedure lasting for a first time period. The light emitting module 140 includes a plurality of indicator lights 142, 144, 146, and 148. Each indicator light 142, 144, 146, and 148 provides an indication function such as power indication or airplane mode indication. The control unit 160 is electrically connected to the computer system 120 and the light emitting module 140. The control unit 160 detects whether the computer system 120 enters the boot procedure, and accordingly controls the light emitting module 140. In an embodiment, the control unit 160 is a microcontroller.

When the control unit 160 detects that the computer system 120 enters the boot procedure, the control unit 160 controls the indicator lights 142 to generate a first light emitting effect within a second time period, instead of performing original indication functions of the indicator lights. The first light emitting effect is a dynamic light emitting effect. In an embodiment, the plurality of indicator lights alternately emits light, flash synchronously, or the like. The second time period is shorter than the first time period of the boot procedure, so as to ensure that the first light emitting effect is completely presented in the boot procedure. The light emitting module 140 and the first light emitting effect generated by the light emitting module are described in more detail in subsequent paragraphs.

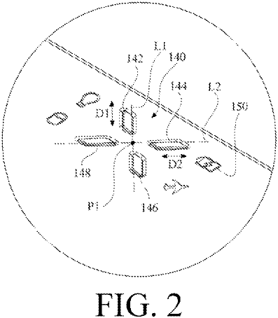

FIG. 2 is a schematic three-dimensional diagram of a light emitting module 140 according to an embodiment of the disclosure. The light emitting module 140 in the figure is disposed on a casing of the electronic device.

As shown in the figure, the light emitting module 140 includes four indicator lights 142, 144, 146, and 148. The four indicator lights 142, 144, 146, and 148 are elongated. The indicator lights 142 and 146 are arranged along a first straight line L1, and the direction of the first straight line L1 is a first direction D1. The indicator lights 144 and 148 are arranged along a second straight line L2, and the direction of the second straight line L2 is a second direction D2. The first straight line L1 and the second straight line L2 intersect at an intersection point P1. The indicator lights 142, 144, 146, and 148 are symmetrically distributed on the casing with the intersection point P1 as the center, and are generally arranged in an X shape.

In an embodiment, the indicator lights 142, 144, 146, and 148 are provided with different functional identifiers 150 beside the indicator lights, to inform a user of an indication function of each indicator light 142, 144, 146, and 148. In an embodiment, the functional identifiers 150 include airplane mode indication, power indication, and the like. In addition, in an embodiment, the indicator lights 142, 144, 146, and 148 use white light-emitting diode elements. However, the disclosure is not limited thereto. In other embodiments, the indicator lights 142, 144, 146, and 148 use other monochromatic light-emitting diode elements, or color light-emitting diode elements that are controlled to change color.

The number of the indicator lights 142, 144, 146, and 148 is merely an embodiment of the disclosure, and the disclosure is not limited thereto. According to an actual requirement, when more function types need to be indicated, more indicator lights are provided. When fewer function types need to be indicated, the number of the indicator lights is reduced.

The indicator lights 142, 144, 146, and 148 are designed as long strips, which is merely an embodiment of the disclosure, and the disclosure is not limited thereto. In other embodiments, the indicator lights 142, 144, 146, and 148 are presented in other shapes, such as circles, triangles, squares, or hexagons.

The indicator lights 142, 144, 146, and 148 are arranged in an X-shape, which is an embodiment of the disclosure, and the disclosure is not limited thereto. Other arrangement manners that effectively present dynamic light emitting effects are also applicable to the disclosure. In an embodiment, the indicator lights are arranged along a straight line or an arc.

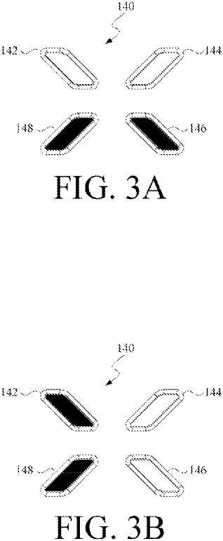

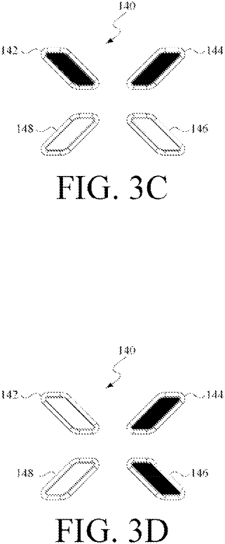

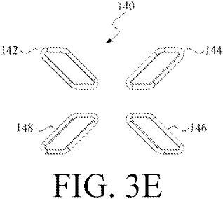

FIG. 3A to FIG. 3E show a first light emitting effect generated by a light emitting module according to an embodiment of the disclosure. The light emitting module 140 in the figure includes four indicator lights 142, 144, 146, and 148 to present a dynamic light emitting effect.

The first light emitting effect in this embodiment is divided into two intervals, which are a cyclic light emitting period (corresponding to FIG. 3A to FIG. 3D) and a full light emitting period (corresponding to FIG. 3E).

Referring to 3A to 3D, when the computer system 120 enters the boot procedure, the control unit 160 first controls the four indicator lights 142, 144, 146, and 148 to emit light in sequence (that is, the cyclic light emitting period). In an embodiment, as shown in the figure, the control unit 160 controls the four indicator lights 142, 144, 146, and 148 to sequentially emit light in two by two in a clockwise direction, and a light emitting time of each group of indicator lights is generally the same, to produce a cyclic light emitting effect.

However, the disclosure is not limited thereto. In other embodiments, the control unit 160 also controls the four indicator lights 142, 144, 146, and 148 to emit light in sequence with a single indicator light as a unit. In addition, the control unit 160 also controls the four indicator lights 142, 144, 146, and 148 to sequentially emit light in a counterclockwise direction.

After the cyclic light emitting is completed, referring to 3E, the control unit 160 controls the four indicator lights 142, 144, 146, and 148 to emit light at the same time (that is, the full light emitting period), to inform the user that the boot procedure is about to be completed. After the boot procedure is completed, the four indicator lights 142, 144, 146, and 148 return to original indication functions of the indicator lights.

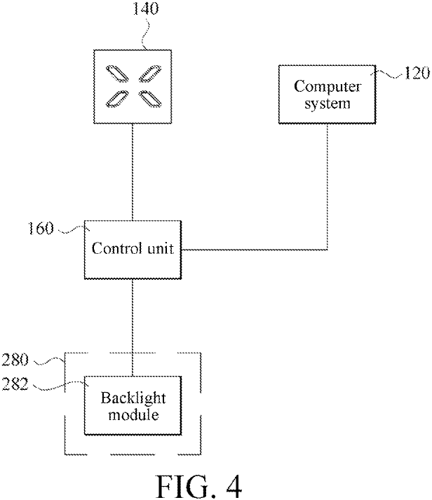

FIG. 4 is a schematic block diagram of an electronic device according to another embodiment of the disclosure.

Compared with the embodiment in FIG. 1, an electronic device 200 in this embodiment further includes a backlight keyboard 280. The backlight keyboard 280 includes a backlight module 282.

The control unit 160 is electrically connected to the computer system 120, the light emitting module 140, and the backlight keyboard 280. The control unit 160 controls light emitting modes of the light emitting module 140 and the backlight keyboard 280 according to a state of the computer system 120. Compared with the light emitting module 140, the backlight module 282 presents different light emitting effects.

When the control unit 160 detects that the computer system 120 enters the boot procedure, in addition to that the control unit 160 controls the light emitting module 140 to generate a first light emitting effect, the control unit 160 controls the backlight module 282 of the backlight keyboard 280 to generate a second light emitting effect different from the first light emitting effect. In an embodiment, the control unit 160 controls the backlight module 282 to generate a third light emitting effect different from the first light emitting effect after controlling the light emitting module 140 to generate the first light emitting effect. In an embodiment, the control unit 160 simultaneously controls the light emitting module 140 and the backlight module 282 to generate a light emitting effect.

After the boot procedure ends, the light emitting module 140 returns to its original indication function, and the backlight module 282 of the backlight keyboard 280 also returns to its original light emitting mode during normal operation.

The first light emitting effect presented by the light emitting module 140 is described in the foregoing paragraphs, and details are not repeated herein. For example, the second light emitting effect presented by the backlight module 282 of the backlight keyboard 280 is whole region lighting, whole region blinking, subregion alternate lighting, or the like.

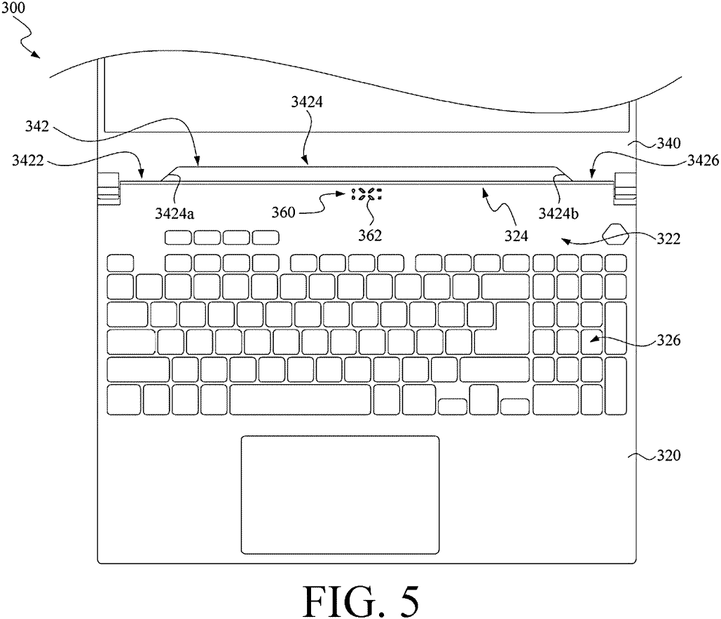

FIG. 5 is a schematic three-dimensional diagram of an electronic device according to an embodiment of the disclosure. In the figure, a notebook computer is used as an example.

As shown in the figure, an electronic device 300 includes a first body 320, a second body 340, and a light emitting module 360. The first body 320 is a main part of the electronic device 300. A computer system and a control unit for controlling the light emitting module 360 are located in the first body 320.

The first body 320 includes a first surface 322 and a first side 324. The first surface 322 serves as a main operating region for a user. A backlight keyboard 326 is disposed on the first surface 322. The first side 324 is located on a side of the first body 320 away from the user.

The second body 340 is a screen part of the electronic device 300, and includes a second side 342 corresponding to the first side 324 of the first body 320. The second side 342 sequentially includes a first connecting section 3422, a concave section 3424, and a second connecting section 3426. The first connecting section 3422 and the second connecting section 3426 are pivotally connected to the first side 324. The concave section 3424 is located between the first connecting section 3422 and the second connecting section 3426, that is, located in the middle of the second side 342. The concave section 3424 respectively includes a first bevel edge 3424a and a second bevel edge 3424b at positions near the first connecting section 3422 and the second connecting section 3426. In an embodiment, the first bevel edge 3424a and the second bevel edge 3424b are symmetrical with each other, so that the concave section 3424 presents in a symmetrical trapezoid shape as a whole.

The light emitting module 360 includes a plurality of indicator lights 362, and the indicator lights 362 are located at positions on the first surface 322 adjacent to the first side 324.

When the second body 340 covers the first body 320, the concave section 3424 of the second body 340 exposes the indicator lights 362 of the light emitting module 360 to the outside. In this way, even if the electronic device 300 is in a covered state, the user checks the indicator lights 362 through the concave section 3424 of the second body 340, to confirm a state of the electronic device 300.

According to the disclosure, after the computer system 120 enters the boot procedure, the indicator lights 142, 144, 146, 148, 362 of the electronic devices 100, 200, 300 are directly configured to present a dynamic first light emitting effect, to inform a user that the computer system 120 is booting. Therefore, the electronic devices 100, 200, 300 in the disclosure do not need to additionally set light signals for a light emitting effect of the boot procedure. In addition, these indicator lights 142, 144, 146, 148, 362 inform the user that the computer system 120 is booting, and a configuration mode of combining the dynamic light emitting effect and the indicator lights 142, 144, 146, 148, 362 also show a special sense of ritual, which highlights the uniqueness of the electronic device.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An electronic device, comprising:
a computer system, adapted to execute a boot procedure, the boot procedure lasting for a first time period;
a light emitting module, comprising a plurality of indicator lights, each indicator light providing an indication function; and
a control unit, electrically connected to the light emitting module, wherein
the control unit controls the indicator lights to generate a first light emitting effect within a second time period when the computer system enters the boot procedure, the second time period is shorter than the first time period.

2. The electronic device according to claim 1, further comprising a keyboard, the keyboard comprising a backlight module, wherein the backlight module generates a second light emitting effect when the computer system enters the boot procedure.

3. The electronic device according to claim 1, further comprising a keyboard, the keyboard comprising a backlight module, wherein the backlight module generates a third light emitting effect after the first light emitting effect ends.

4. The electronic device according to claim 1, wherein the first light emitting effect is a dynamic light emitting effect.

5. The electronic device according to claim 1, wherein the first light emitting effect comprises a cyclic light emitting period and a full light emitting period.

6. The electronic device according to claim 5, wherein the cyclic light emitting period is earlier than the full light emitting period.

7. The electronic device according to claim 1, wherein the light emitting module comprises four indicator lights.

8. The electronic device according to claim 1, further comprising a first body and a second body, wherein the first body comprises a first surface, the first surface comprises a first side, the second body is pivotally connected to the first side, and the indicator lights are located on the first surface and adjacent to the first side.

9. The electronic device according to claim 8, wherein the second body comprises a second side, the second body is pivotally connected to the first side by the second side, the second side comprises a concave section, and when the second body covers the first body, the concave section exposes the indicator lights.

10. The electronic device according to claim 8, further comprising a keyboard, disposed on the first surface.
